(19) United States
(12) Patent Application Publication
(10) Pub. No.: US 2020/0034136 A1
(43) Pub. Date: Jan. 30, 2020

(54) DISTRIBUTED ASSET MANAGEMENT IN OPERATING THEATER

(71) Applicant: Sony Corporation, Tokyo (JP)

(72) Inventor: Robert KONINCKX, Stuttgart (DE)

(73) Assignee: Sony Corporation, Tokyo (JP)

(21) Appl. No.: 16/458,191

(22) Filed: Jul. 1, 2019

(30) Foreign Application Priority Data
Jul. 24, 2018 (EP) 18185366.4

(51) Int. Cl. G06F 8/65; G06F 11/36; G06F 9/4401

(52) U.S. Cl. CPC G06F 8/65; G06F 9/4416; G06F 9/4408; G06F 11/3668

(57) ABSTRACT

A method for updating software of a component installed in an operating theater is disclosed. The component thereby is connected to a network and comprises at least two boot slots. The method comprises the steps of identifying a boot slot that is currently not the current default boot slot being used for booting and for installing the software to be installed on the component on the identified boot slot that is currently not being used for booting. The method also comprises testing the software to be installed by booting the component from the identified boot slot with the installed software, and if the testing of the software is successful, redefining the identified boot slot as the new default boot slot or if the testing of the software is unsuccessful, maintaining the current default boot slot.

### CROSS-REFERENCE TO RELATED APPLICATION

The present application claims priority to European Patent Application 18185366.4 filed by the European Patent Office on Jul. 24, 2018, the entire contents of which is being incorporated herein by reference.

### TECHNICAL FIELD OF THE DISCLOSURE

The present disclosure relates to the field of operating theaters. More specifically, it relates to methods and systems for updating software of components in operating theaters thus allowing asset management in operating theaters, as well as to components in operating theaters configured for allowing such software updates.

### BACKGROUND OF THE DISCLOSURE

The increased modernization of operating theaters, where surgery is performed, has lead to such operating theaters comprising high-tech installations with numerous components, also referred to as intelligent endnodes. Examples of such components are displays, computers, audio-visual communication components, IPC, . . . . Potentially an operating theater comprises hundreds of intelligent endnodes. Each of these components needs to be kept up to date. For example, often such components run on software, firmware or embedded software, and for each of these components the software needs to be up to date. A number of problems are known, some of these having a significant impact on the operational time of the operating theater. Some of these problems are being indicated below.

Maintaining of components typically requires a lot of interaction by technicians, since the components need to be individually updated. Typically, the technician needs to enter the operating theater, and typically such updating is to be performed when no surgery is performed, resulting in downtime of the operating theatre. Furthermore, since numerous components interact with each other, upon updating software of one component, incompatibility with the other components may occur. This typically results in the update to be undone or in a patch to be installed, which again results in downtime of the operating theater. The situation even may become dangerous if such incompatibility only appears afterwards during use of the operating theater as it may result in non-functioning of components during surgery. Consequently, there is room for improvement.

### SUMMARY OF THE DISCLOSURE

It is an object of embodiments of the present disclosure to provide good methods and systems for updating components in an operating theater. It is an advantage of embodiments of the present disclosure that the downtime of the operating theater can be minimized. It is an advantage of embodiments of the present disclosure that interference with the running installation of the operating theater can be minimized. It is an advantage of embodiments of the present disclosure that the updating of components in the operating theater can be performed in a highly automated way, requiring little or no physical access of the technicians in the operating theater.

The present disclosure relates to a method of updating software of a component installed in an operating theater, the component being connected to a network and comprising at least two boot slots, the method comprising identifying a boot slot that is currently not the current default boot slot being used for booting

installing the software to be installed on the component on the identified boot slot that is currently not being used for booting,
testing the software to be installed by booting the component from the identified boot slot with the installed software, and
if the testing of the software is successful, redefining the identified boot slot as the new default boot slot or if the testing of the software is unsuccessful, maintaining the current default boot slot.

It is an advantage of embodiments of the present disclosure that methods and systems are provided that allow to guarantee compatibility of different firmware or embedded software of individual nodes, since after an update the booting and the compatibility with other components can be checked, and if there are booting or compatibility problems, the previous version typically still is available.

Testing of the software may comprise checking compatibility with other components of the operating theatre interacting with the updated component. It is an advantage of embodiments of the present disclosure that compatibility can be check when updating software of a component so that operations in the operating theater cannot be disturbed by software updates in components of the operating theater. It is an advantage that it can be guaranteed that the different firmware or embedded software for different components are compatible, since if due an update of the software of a component this would not be the case, the updated component can still be used with the previously used software. It thus is advantageous that a previous version of the software remains available until the new software can successfully be used, and even thereafter.

the installation of the software may be performed over the network in the operating theater. It is an advantage of embodiments of the present disclosure that updating of components of the operating theater, as well as testing, can be performed over the network in an automated way. The network functions as the connecting factor between all elements in the operating theater. The latter has the advantage that there is no need for technicians running around to every device. It is an advantage of embodiments of the present disclosure that there the different components can be accessed over the network, thus resulting in the components to be easy to find. It is an advantage of embodiments of the present disclosure that devise are easily accessible through the network and that therefore there is no need to physically access components that are physically difficult to access. It is an advantage that a better hygiene can be maintained in the operating theater since less technicians need to enter the operating theater. It is an advantage of embodiments of the present disclosure that updating software of the components is less time consuming since no physical access to the component itself is required but the update can be performed over the network.

The testing of the software to be installed can be performed at a moment in time the component and optionally other components in the operating theater are not in use. It is an advantage of embodiments of the present disclosure that interference between the software updating process and the proper use of the components in the operating theater can be avoided, while still at least part of the software updating process can be performed during use of the components.

The method further may comprise gathering operational information regarding the component over the network. It is an advantage of embodiments of the present disclosure that such operational information can be used for example for managing the components and/or for guaranteeing proper operation of the components and/or for estimating wear of components and/or for keeping an inventory of the software version the different components are operating at.

Predictive or preventive maintenance of a component may be performed based on the gathered operational information. It is an advantage of embodiments of the present disclosure that the number of working hours of a component and therefore the amount of wear that can be present can be monitored and managed. It is an advantage of embodiments of the present disclosure that prediction of an operational parameter, e.g. when a printer will be running out of paper or running out of ink, can be performed.

The components may comprise one or more of a monitor, a printer, a camera, an IPC, a switch, a router, a computer or a network component. It is an advantage of embodiments of the present disclosure that all components of the operating theater can be software updated using the present method.

The present disclosure also relates to a system for updating software of components in an operating theater, the system comprising

a plurality of components interconnected via a network, each of the components comprising at least two boot slots,
a controller configured for, over the network, identifying, for a component for which the software is to be updated, a boot slot that is currently not the current default boot slot being used for booting,
installing the software to be installed on the component on the identified boot slot that is currently not being used for booting by that component,
testing the software to be installed by booting the component from the identified boot slot with the installed software, and
if the testing of the software is successful, redefining the identified boot slot as the new default boot slot, or if the testing of the software is unsuccessful, maintaining the current default boot slot.

The controller may be configured for including in the testing of the software, the checking of the compatibility with other components of the operating theatre interacting with the updated component.

The controller may be configured for performing the testing of the software to be installed at a moment in time that the component and optionally other components in the operating theater are not in use.

The controller may be configured for gathering operational information regarding the component over the network.

The controller may be configured for performing predictive or preventive maintenance of a component based on the gathered operational information.

The components may comprise one or more of a monitor, a printer, a camera, an IPC, a switch, a router, a computer or a network component.

The present disclosure furthermore relates to a component configured for use in an operating theater, the component comprising at least two boot slots and a selector for indicating the boot slot that is currently used as the default boot slot.

The component may be interconnect via a network and may be configured such that software can be installed in the at least two boot slots over the network and such that the selector can be set over the network.

The present disclosure also relates to an operating theater comprising a system as described above.

Particular and preferred aspects of the disclosure are set out in the accompanying independent and dependent claims. Features from the dependent claims may be combined with features of the independent claims and with features of other dependent claims as appropriate and not merely as explicitly set out in the claims. These and other aspects of the disclosure will be apparent from and elucidated with reference to the embodiment(s) described hereinafter.

### BRIEF DESCRIPTION OF THE DRAWINGS

FIG. 1 is a schematic overview of typical steps in a method for updating/upgrading software for components in an operating theater.

FIG. 2 is a schematic overview of a component according to an embodiment of the present disclosure.

FIG. 3 is a schematic overview of a system according to an embodiment of the present disclosure.

FIG. 4 is an exemplary operating theater for which components can be updated using a method according to an embodiment of the present disclosure.

The drawings are only schematic and are non-limiting. In the drawings, the size of some of the elements may be exaggerated and not drawn on scale for illustrative purposes. Any reference signs in the claims shall not be construed as limiting the scope. In the different drawings, the same reference signs refer to the same or analogous elements.

### DETAILED DESCRIPTION OF ILLUSTRATIVE EMBODIMENTS

The present disclosure will be described with respect to particular embodiments and with reference to certain drawings but the disclosure is not limited thereto but only by the claims. The dimensions and the relative dimensions do not correspond to actual reductions to practice of the disclosure.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the disclosure described herein are capable of operation in other sequences than described or illustrated herein. Moreover, the terms top, under and the like in the description and the claims are used for descriptive purposes and not necessarily for describing relative positions. It is to be understood that the terms so used are interchangeable under appropriate circumstances and that the embodiments of the disclosure described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present disclosure, the only relevant components of the device are A and B.

Reference throughout this specification to “one embodiment” or “an embodiment” means that a particular feature, structure or characteristic described in connection with the embodiment is included in at least one embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the disclosure, various features of the disclosure are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

In a first aspect, the present disclosure relates to a method of updating software of a component installed in an operating theater. The method typically is applicable for operating theaters having a large number of components, also referred to as intelligent endnodes. An example of an operating theater will be described further down below. According to embodiments of the present disclosure, the method is applied to operating theaters wherein the components are connected to a network. Such a network may be any type of network, i.e. wired or unwired or combined, an intranet or internet, etc. The components furthermore comprise at least two boot slots. The redundancy of at least one boot slot is essential to the method. The number of boot slots, provided it is at least two, is not limited in embodiments of the present application. The method according to embodiments of the present disclosure comprises the step of identifying a boot slot that is currently not the current default boot slot being used for booting. The latter may for example be based on checking of a selector at the component or positioned in the network and identifying which boot slot is identified as the current default boot slot, i.e. the boot slot comprising the software that is currently used for operating the component. According to embodiments of the present disclosure, the method also comprises installing the software to be installed on the component on the identified boot slot that is currently not being used for booting. Since there are at least two boot slots for each component, there is always a boot slot available that is not the default one used by the component. Installing the software may include overwriting an old version of the software that is currently not used. This means that the version of the software that is currently used remains available, even though the new version will already be installed on the component. The method also comprises testing the software to be installed by booting the component from the identified boot slot with the installed software. Such testing includes the fact that the component indeed can boot based on the new software. Nevertheless, in some embodiments such testing further may include checking if the component, based on the new software used, does not conflict with other components. The testing typically may be performed during downtime of the operating theater, unless the testing does not result in a conflict causing components in the operating theater to close down or block. The method further includes a decision step as follows: If the testing of the software is successful, the new software can be used and the identified boot slot can be redefined as the new default boot slot so that as from then the new software is used. This may be performed by changing the selector to indicate the identified boot slot as new default boot slot. If the testing of the software is unsuccessful, the current default boot slot is maintained. The method then typically may comprise a step of notifying the installer/technician.

According to particular embodiments of the present disclosure, the installation of the software is performed over the network in the operating theater. This allows for avoiding that technicians need to enter the operating theater for updating software of components installed in the operating theater. It is to be noted that the method may be implemented also for additional components that are not positioned in the operating theater but that are for example interconnected with components in the operating theater and consequently may have an effect on the components functioning in the operating theater. Furthermore, even additional components not linked to components in the operating theater may be updated using the method.

According to embodiments of the present disclosure, the method further may comprise gathering operational information regarding the component over the network. Such information can for example be used for managing the components and/or for guaranteeing proper operation of the components and/or for estimating wear of components and/or for keeping an inventory of the software version the different components are operating at. The information can in one embodiment also be used for predictive or preventive maintenance of a component. For example, based on the number of operating time, it may be decided to replace a component or part thereof, taking into account a typical lifetime of such a component or component part.

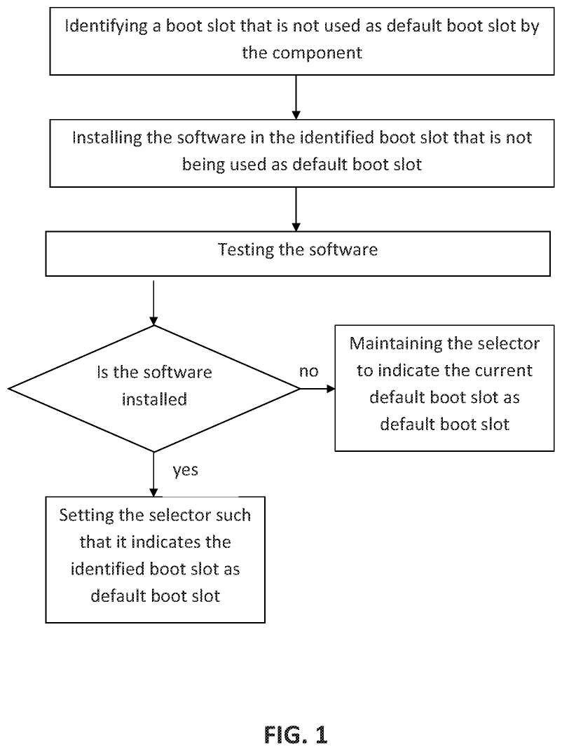

FIG. 1 illustrates an overview of an exemplary method according to an embodiment of the present disclosure.

In a second aspect, the present disclosure relates to a component configured for use in an operating theater. The component comprising at least two boot slots and a selector for indicating the boot slot that is currently used as the default boot slot. A boot slot is known by the person skilled in the art and corresponds with a memory storing the software required for booting and/or operating the component. In embodiments of the present application, at least one redundant boot slot is available, i.e. there are at least two boot slots. The new software with which the component is to be updated or upgraded thus can be installed without the default software that is currently used for booting the component needing to be removed. The selector may be a memory field comprising an indication of the boot slot that is currently used as the default boot slot. Based on this indication, a boot slot that is not being used as default at present can be selected for installing the new software. The installation as well as the setting of the selector typically will be performed over the network, so the component and the boot slots and selectors typically may be adapted therefore.

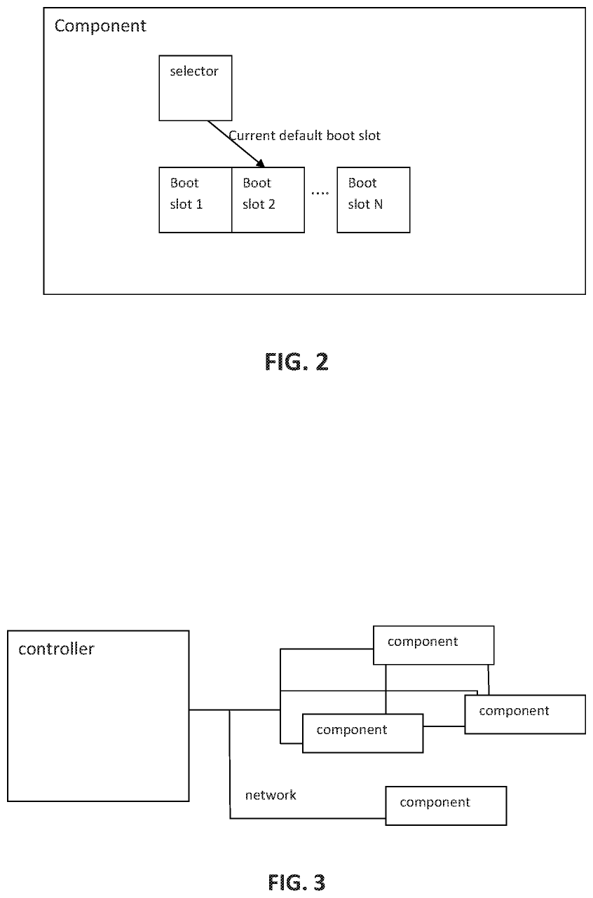

FIG. 2 illustrates an example of a component according to an embodiment of the present disclosure.

In a third aspect, the present disclosure also relates to a system for updating software of components in an operating theater. According to embodiments, the system comprises a plurality of components interconnected via a network, each of the components comprising at least two boot slots and a selector for indicating which boot slot is used as default boot slot for running the default software for booting and/or operating the component. The system also comprises a controller configured for, over the network, identifying, for a component for which the software is to be updated, a boot slot that is currently not the current default boot slot being used for booting and configured for installing the software to be installed on the component on the identified boot slot that is currently not being used for booting by that component. The controller also is configured for, testing the software to be installed by booting the component from the identified boot slot with the installed software. If the testing of the software is successful, the identified boot slot is redefined as the new default boot slot. This typically is performed by adjusting the selector indicative of the current default boot slot. If the testing of the software is unsuccessful, the current default boot slot is maintained and typically the system will provide an output to the technician that the update was unsuccesful.

The controller may be implemented as software or as hardware. It may for example be based on a predetermined algorithm, it may comprise parts of a neural network or may be based on look up tables. The controller may be implemented in or on a processor, processors being known by the person skilled in the art. Further features of the system may correspond with elements providing the functionality of the standard and optional steps as described for the method for updating software of components in an operating theater as described in the first aspect. FIG. 3 illustrates a schematic representation of a system according to an exemplary embodiment of the present disclosure.

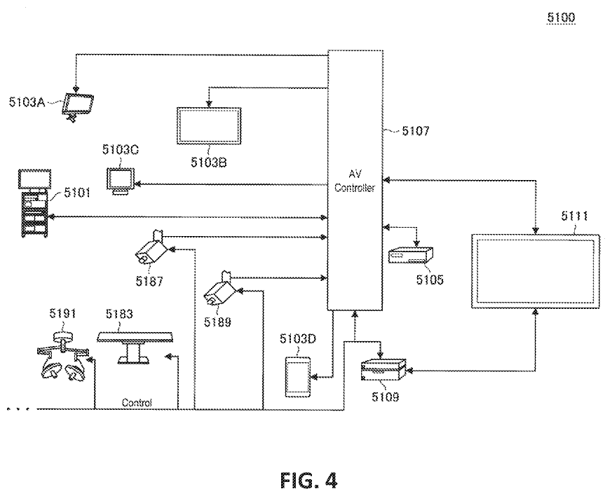

In a fourth aspect, the present disclosure also relates to an operating theater comprising a system for updating/upgrading software of components of the operating theater as described in the third aspect. With respect to the operating theater, by way of example and the disclosure not being limited thereto, an example is described with reference to FIG. 4. An example of the system for updating/upgrading software of components, the disclosure not being limited thereto is shown in FIG. 3.

FIG. 4 is a view illustrating an example of a state of surgery applied to a surgery room system according to the prior art. As will be apparent, the components envisaged can be a plurality of different components such as cameras, monitors, processors, IPC, network components, . . . . In the example shown, a ceiling camera 5187 and a surgery field camera 5189 are provided on the ceiling of the surgery room such that it can image the hands of a surgeon (medical doctor) 5181 who performs treatment for an affected area of a patient 5185 on a patient bed 5183 and the entire surgery room. An illumination 5191 is provided on the ceiling of the surgery room and irradiates at least upon the hands of the surgeon 5181.

The endoscopic surgery system 5113, the patient bed 5183, the ceiling camera 5187, the surgery field camera 5189 and the illumination 5191 can be connected for cooperation with each other, e.g. through an audiovisual controller and a surgery room controlling apparatus. A centralized operation panel 5111 can provided in the surgery room, and the user can suitably operate the apparatus existing in the surgery room through the centralized operation panel 5111.

Still referring to FIG. 4, a configuration of an endoscopic surgery system 5113 is described in detail. It includes an endoscope 5115, other surgical tools 5131, a supporting arm apparatus 5141 which supports the endoscope 5115 thereon, and a cart 5151 on which various apparatus for endoscopic surgery are mounted.

In endoscopic surgery, in place of incision of the abdominal wall to perform laparotomy, a plurality of tubular aperture devices called trocars 5139a to 5139d can be used to puncture the abdominal wall. Then, a lens barrel 5117 of the endoscope 5115 and the other surgical tools 5131 are inserted into body lumens of the patient 5185 through the trocars 5139a to 5139d. In the example depicted, as the other surgical tools 5131, a pneumoperitoneum tube 5133, an energy treatment tool 5135 (for performing incision, peeling, sealing vessels or the like by high frequency current or ultrasonic vibration) and forceps 5137 are inserted into body lumens of the patient 5185. However, the surgical tools 5131 depicted are mere examples. Various surgical tools which are generally used in endoscopic surgery such as, for example, a pair of tweezers or a retractor may be used.

An image of a surgical region in a body lumen of the patient 5185 picked up by the endoscope 5115 can be displayed on a display apparatus 5155. A pneumoperitoneum apparatus 5165 can be used to feed gas into a body lumen of the patient 5185 through the pneumoperitoneum tube 5133 to inflate the body lumen in order to secure the field of view of the endoscope 5115 and secure the working space for the surgeon. The surgeon 5181 can use the energy treatment tool 5135 or the forceps 5137 while watching the image of the surgical region displayed on the display apparatus 5155 to perform such treatment as, for example, resection of an affected area.

The endoscope 5115 may include a lens barrel 5117 which has a region of a predetermined length from a distal end thereof to be inserted into a body lumen of the patient 5185, and a camera head 5119 connected to a proximal end of the lens barrel 5117. The endoscope 5115 of FIG. 1 is depicted as a hard mirror having the lens barrel 5117 of the hard type, but the endoscope 5115 may otherwise be configured as a soft mirror having the lens barrel 5117 of the soft type.

The lens barrel 5117 has, at a distal end thereof, an opening in which an objective lens is fitted. A light source apparatus 5157 is connected to the endoscope 5115 such that light generated by the light source apparatus 5157 is introduced to a distal end of the lens barrel 5117 by a light guide extending in the inside of the lens barrel 5117 and is applied toward an observation target in a body lumen of the patient 5185 through the objective lens. The endoscope 5115 may be a direct view mirror or may be a perspective view mirror or a side view mirror.

An optical system and an image pickup element are provided in the inside of the camera head 5119 such that reflected light (observation light) from an observation target is condensed on the image pickup element by the optical system. The observation light is photo-electrically converted by the image pickup element to generate an electric signal corresponding to the observation light, namely, an image signal corresponding to an observation image. The image signal can be transmitted as RAW data to a camera control unit (CCU) 5153. The camera head 5119 may have a function incorporated therein for suitably driving the optical system of the camera head 5119 to adjust the magnification and the focal distance.

The CCU 5153 may include a central processing unit (CPU), a graphics processing unit (GPU) or the like and may integrally control operation of the endoscope 5115 and/or the display apparatus 5155. For example the CCU 5153 performs, for an image signal received from the camera head 5119, various image processes for displaying an image based on the image signal such as, for example, a development process (demosaic process). The CCU 5153 provides the image signal for which the image processes have been performed to the display apparatus 5155. The CCU 5153 may be connected to an audiovisual controller and provide the image signal for which the image processes have been performed.

Further, the CCU 5153 may include a communication unit for transmitting a control signal to the camera head 5119 to control driving of the camera head 5119. The control signal may include information relating to an image pickup condition such as information that a frame rate of a picked up image is designated, information that an exposure value upon image picking up is designated and/or information that a magnification and a focal point of a picked up image are designated. Further, the camera head 5119 may include a communication unit for receiving a control signal for controlling driving of the camera head 5119 from the CCU 5153. The communication unit provides the received control signal to a camera head controlling unit 5129.

1. A method of updating software of a component installed in an operating theater, the component being connected to a network and comprising at least two boot slots, the method comprising
Identifying a boot slot that is currently not the current default boot slot being used for booting
Installing the software to be installed on the component on the identified boot slot that is currently not being used for booting,
Testing the software to be installed by booting the component from the identified boot slot with the installed software, and
If the testing of the software is successful, redefining the identified boot slot as the new default boot slot or if the testing of the software is unsuccessful, maintaining the current default boot slot.

2. The method according to claim 1, wherein testing of the software comprises checking compatibility with other components of the operating theatre interacting with the updated component.

3. The method according to claim 1, wherein the installation of the software is performed over the network in the operating theater.

4. The method according to claim 1, wherein the testing of the software to be installed can be performed at a moment in time the component and optionally other components in the operating theater are not in use.

5. The method according to claim 1, wherein the method further comprises gathering operational information regarding the component over the network.

6. The method according to claim 1, wherein predictive or preventive maintenance of a component is performed based on the gathered operational information.

7. The method according to claim 1, wherein the components comprise one or more of a monitor, a printer, a camera, an IPC, a switch, a router, a computer or a network component.

8. A system for updating software of components in an operating theater, the system comprising
A plurality of components interconnected via a network, each of the components comprising at least two boot slots,
a controller configured for, over the network,
Identifying, for a component for which the software is to be updated, a boot slot that is currently not the current default boot slot being used for booting,
Installing the software to be installed on the component on the identified boot slot that is currently not being used for booting by that component,
Testing the software to be installed by booting the component from the identified boot slot with the installed software, and
If the testing of the software is successful, redefining the identified boot slot as the new default boot slot, or
if the testing of the software is unsuccessful, maintaining the current default boot slot.

9. The system according to claim 8, wherein the controller is being configured for including in the testing of the software, the checking of the compatibility with other components of the operating theatre interacting with the updated component.

10. The system according to claim 8,
wherein the controller is configured for performing the testing of the software to be installed at a moment in time that the component and optionally other components in the operating theater are not in use.

11. The system according to claim 8, wherein the controller is configured for gathering operational information regarding the component over the network.

12. The system according to claim 11, wherein the controller is configured for performing predictive or preventive maintenance of a component based on the gathered operational information.

13. The system according to claim 8, wherein the components comprise one or more of a monitor, a printer, a camera, an IPC, a switch, a router, a computer or a network component.

14. A component configured for use in an operating theater, the component comprising at least two boot slots and a selector for indicating the boot slot that is currently used as the default boot slot.

15. A component according to claim 14, wherein the component is interconnect via a network and configured such that software can be installed in the at least two boot slots over the network and such that the selector can be set over the network.
